(19) United States
(12) Patent Application Publication
(10) Pub. No.: US 2014/0326380 A1
(43) Pub. Date: Nov. 6, 2014

(54) Pneumatic Tire

(71) Applicant: Koichi Kotoku, Hiratsuka-shi (JP)

(72) Inventor: Koichi Kotoku, Hiratsuka-shi (JP)

(73) Assignee: The Yokohama Rubber Co., LTD., Tokyo (JP)

(21) Appl. No.: 14/346,218

(22) PCT Filed: Sep. 22, 2011
(86) PCT No.: PCT/JP2011/071685

§ 371 Date: May 15, 2014

(51) Int. Cl. B60C 9/28; B60C 9/00

(52) U.S. Cl. CPC B60C 9/28; B60C 9/0007
USPC 152/209.18; 152/209.1

(57) ABSTRACT

The pneumatic tire includes a carcass layer and a belt layer that is formed by laminating a pair of cross belts and a circumferential reinforcing layer and that is disposed outward in a tire radial direction from the carcass layer. Additionally, the pneumatic tire includes a plurality of circumferential main grooves extending in a tire circumferential direction, and a plurality of land portions partitioned by the circumferential main grooves in a tread portion. Also, an end portion on the outer side in the tire width direction of the circumferential reinforcing layer is on the outer side in the tire width direction of a normal line m that is drawn from a point P at an edge portion on the inner side in a tire width direction of a shoulder land portion to the carcass layer.

### Technical Field

The present invention relates to a pneumatic tire, and more particularly relates to a pneumatic tire that can improve the uneven wear resistance.

### BACKGROUND

Conventional pneumatic tires have a circumferential reinforcing layer in a belt layer in order to suppress the radial growth of tires. The technology disclosed in Japanese Unexamined Patent Application Publication No. 2010-120431A is a conventional pneumatic tire that is configured in this manner.

However, in the configuration having the circumferential reinforcing layer in the belt layer, there is a problem that uneven wear (in particular, step wear of a shoulder land portion) can easily occur, compared with a configuration without a circumferential reinforcing layer in the belt layer.

### SUMMARY

The present technology provides a pneumatic tire whereby uneven wear resistance can be improved. The present technology is a pneumatic tire that includes: a carcass layer, and a belt layer that is formed by laminating a pair of cross belts and a circumferential reinforcing layer and that is disposed on an outer side in a tire radial direction from the carcass layer, and a plurality of circumferential main grooves that extend in a tire circumferential direction and a plurality of land portions partitioned by the circumferential main grooves in a tread portion. In such a pneumatic tire, when the circumferential main groove on an outermost side in a tire width direction is referred to as an outermost circumferential main groove, and the land portion on the outer side in the tire width direction that is partitioned by the outermost circumferential main groove is referred to as the shoulder land portion, an end portion on the outer side in the tire width direction of the circumferential reinforcing layer is on the outer side in the tire width direction of a normal line m drawn from a point P at an end portion on an inner side in the tire width direction of the shoulder land portion to the carcass layer, and a distance W1 from the normal line m to the end portion on the outer side in the tire width direction of the circumferential reinforcing layer, and a distance L from the point P to a point T at an end portion on the outer side in the tire width direction of the shoulder land portion have a relationship such that 0.1≦W1/L≦0.4.

In the pneumatic tire according to the present invention, the circumferential reinforcing layer extends below the groove of the outermost circumferential main groove to below the shoulder land portion, so it is possible to reduce the difference in stiffness between the land portions in the tread center region that is demarcated by the outermost circumferential main groove, and the shoulder land portion. This leads to the advantage that uneven wear of the shoulder land portion is suppressed and that the uneven wear resistance performance of the tire is thus improved.

### BRIEF DESCRIPTION OF THE DRAWINGS

FIG. 1 is a cross-sectional view in a tire meridian direction illustrating a pneumatic tire according to an embodiment of the present invention.

FIG. 2 is an explanatory view illustrating a shoulder portion of the pneumatic tire depicted in FIG. 1.

FIG. 3 is an explanatory view illustrating a belt layer of the pneumatic tire depicted in FIG. 1.

FIG. 4 is an explanatory view illustrating a modified example of the pneumatic tire depicted in FIG. 1.

FIG. 5 is an explanatory view illustrating a modified example of the pneumatic tire depicted in FIG. 1.

FIG. 6 is a table showing the results of performance testing of pneumatic tires according to the embodiment of the present invention.

### DETAILED DESCRIPTION

The present invention is described below in detail with reference to the accompanying drawing. However, the present invention is not limited to these embodiments. Moreover, constituents of the embodiment which can possibly or obviously be substituted while maintaining consistency with the present invention are included. Furthermore, the multiple modified examples described in the embodiment can be combined as desired within the scope apparent to a person skilled in the art.

### Pneumatic Tire

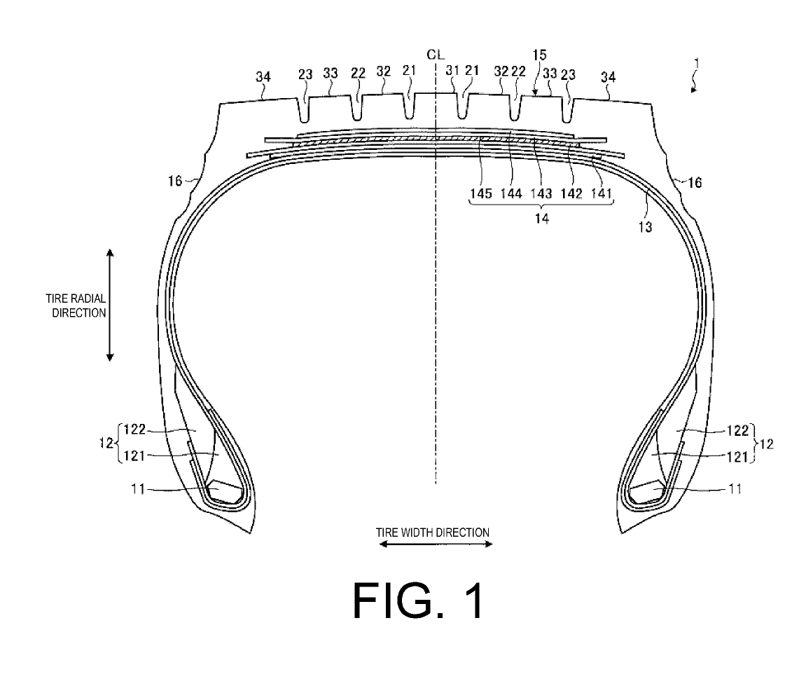

FIG. 1 is a cross-sectional view in a tire meridian direction illustrating a pneumatic tire 1 according to an embodiment of the present invention. In this drawing, a radial tire for heavy loads that is mounted on trucks, buses, and the like for long-distance transport is illustrated as an example of the pneumatic tire 1.

The pneumatic tire 1 includes a pair of bead cores 11,11, a pair of bead fillers 12,12, a carcass layer 13, a belt layer 14, tread rubber 15, and a pair of side wall rubbers 16,16 (see FIG. 1). The pair of bead cores 11,11 have annular structures and constitute cores of left and right bead portions. The pair of bead fillers 12,12 are formed from a lower filler 121 and an upper filler 122, and are disposed on a periphery of each of the pair of bead cores 11,11 in a tire radial direction so as to reinforce the bead portions. The carcass layer 13 has a single-layer structure, and stretches between the left and right bead cores 11 and 11 in toroidal form, forming a framework for the tire. Additionally, both ends of the carcass layer 13 are folded toward an outer side in the tire width direction so as to envelop the bead cores 11 and the bead fillers 12, and fixed. The belt layer 14 is formed from a plurality of belt plies 141 to 145 that are laminated, and is disposed on the periphery of the carcass layer 13 in the tire radial direction. The tread rubber 15 is disposed on the periphery of the carcass layer 13 and the belt layer 14 in the tire radial direction, and forms a tire tread. The pair of side wall rubbers 16,16 is disposed on each outer side of the carcass layer 13 in the tire width direction, so as to form left and right side wall portions of the tire.

Additionally, the pneumatic tire 1 has a plurality of circumferential main grooves 21 to 23 extending in a tire circumferential direction, a plurality of lug grooves (not illustrated) extending in the tire width direction, and a plurality of land portions 31 to 34 partitioned by the circumferential main grooves 21 to 23 and the lug grooves in the tread portion. Thereby, a block-based tread pattern is formed (not illustrated). However, the configuration is not limited thereto, and the pneumatic tire 1 may have a rib pattern (not illustrated). Also, the circumferential main grooves 21 to 23 may be straight grooves, or they may be zigzag grooves.

In this embodiment, the pneumatic tire 1 has a left-right symmetric construction centered on a tire equatorial plane CL.

Note that “circumferential main grooves” refers to circumferential grooves having a groove width of 10 mm or greater.

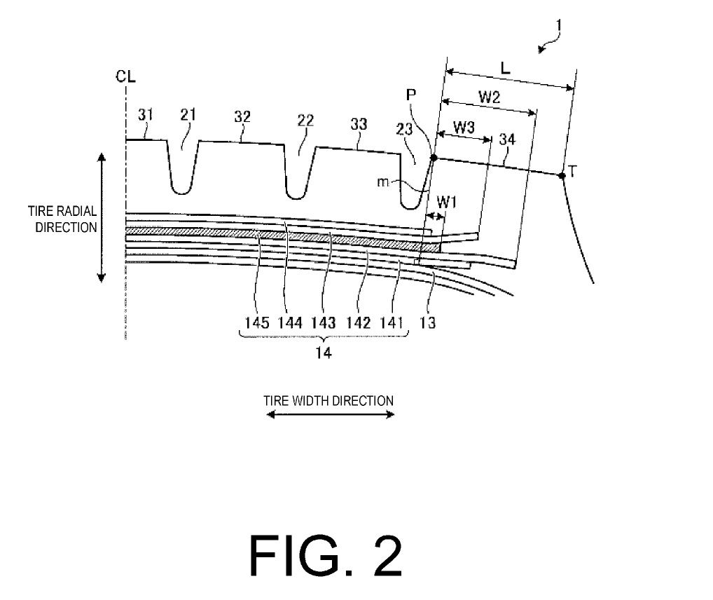

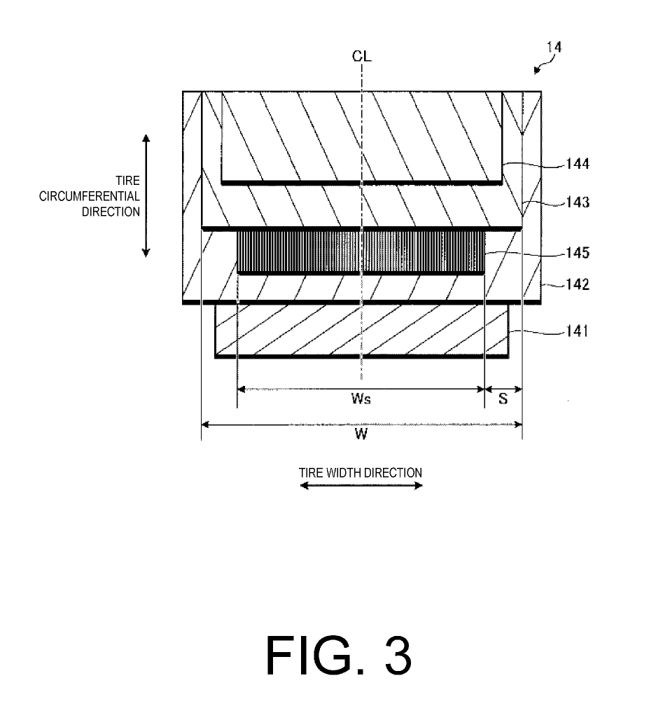

FIG. 2 is an explanatory view illustrating a shoulder portion of the pneumatic tire 1 depicted in FIG. 1. FIG. 3 is an explanatory view illustrating the belt layer 14 of the pneumatic tire 1 depicted in FIG. 1. In these drawings, FIG. 2 illustrates a region on one side of the tread portion demarcated by the tire equatorial plane CL, and FIG. 3 illustrates a laminated structure of the belt layer 14.

Also, the carcass layer 13 is constituted by a plurality of carcass cords formed from steel or organic fibers (for example, nylon, polyester, rayon, or the like), covered by coating rubber, and subjected to a rolling process, having a carcass angle (the angle of inclination of the fiber direction of the carcass cords with respect to the tire circumferential direction) of not less than 85° and not greater than 95° in absolute values.

The belt layer 14 is formed by laminating a high angle belt 141, a pair of cross belts 142, 143, a belt cover 144, and a circumferential reinforcing layer 145, disposed on the periphery of the carcass layer 13 (see FIG. 2).

The high angle belt 141 is configured by a plurality of belt cords formed from steel or organic fibers, covered by coating rubber, and subjected to a rolling process, having a belt angle (angle of inclination of belt cord fiber direction with respect to the tire circumferential direction) of not less than 40° and not more than 60° in absolute values. Also, the high angle belt 141 is disposed so as to be laminated outward in the tire radial direction of the carcass layer 13.

The pair of cross belts 142, 143 are configured by a plurality of belt cords formed from steel or organic fibers, covered by coating rubber, and subjected to a rolling process, having a belt angle of not less than 10° and not more than 30° in absolute values. Additionally, the pair of cross belts 142, 143 have belt angles that are of mutually opposite sign to each other, and are laminated so that the fiber directions of the belt cords intersect each other (a crossply structure). In the following description, the cross belt 142 positioned on the inner side in the tire radial direction is referred to as an “inner-side cross belt”, and the cross belt 143 positioned on the outer side in the tire radial direction is referred to as an “outer-side cross belt”. Three or more cross belts may be disposed so as to be laminated (not illustrated). Also, the pair of cross belts 142, 143 are disposed so as to be laminated outward in the tire radial direction of the high angle belt 141.

The belt cover 144 is configured by a plurality of belt cords formed from steel or organic fibers, covered by coating rubber, and subjected to a rolling process, having a belt angle of not less than 10° and not more than 45° in absolute values. Also, the belt cover 144 is disposed so as to be laminated outward in the tire radial direction of the cross belts 142, 143. In this embodiment, the belt cover 144 has the same belt angle as the outer-side cross belt 143, and, is disposed in the outermost layer of the belt layer 14.

The circumferential reinforcing layer 145 has a configuration in which rubber coated steel belt cords are wound spirally at a slant within a range of ±5° with respect to the tire circumferential direction. Also, the circumferential reinforcing layer 145 is disposed so as to be interposed between the pair of cross belts 142, 143. Also, the circumferential reinforcing layer 145 is disposed inward in the tire width direction of left and right edges of the pair of cross belts 142, 143. Specifically, one or a plurality of wires is wound spirally around the periphery of the inner-side cross belt 142, to form the circumferential reinforcing layer 145. This circumferential reinforcing layer 145 reinforces the stiffness in the tire circumferential direction. As a result, the durability of the tire is improved.

In the pneumatic tire 1, the belt layer 14 may have an edge cover (not illustrated). Generally, the edge cover is constituted by a plurality of belt cords formed from steel or organic fibers, covered by coating rubber, and subjected to a rolling process, having a belt angle of not less than 0° and not greater than 5° in absolute values. Also, the edge cover is disposed outward in the tire radial direction of the left and right edges of the outer-side cross belt 143 (or the inner-side cross belt 142). As a result of the band effect of the edge cover, the difference in radial growth of a tread center region and a shoulder region is reduced, and the uneven wear resistance performance of the tire is improved.

### Circumferential Reinforcing Layer

Generally, in the configuration having the circumferential reinforcing layer in the belt layer, there is a problem that uneven wear (in particular, step wear of the shoulder land portion) can easily occur, compared with a configuration without a circumferential reinforcing layer in the belt layer.

Therefore, the following configuration is adopted in the pneumatic tire 1 in order to suppress uneven wear caused by the circumferential reinforcing layer (see FIG. 2).

First, a circumferential main groove 23 on the outermost side in the tire width direction is referred to as the outermost circumferential main groove. Also, the land portion 34 on the outer side in the tire width direction that is partitioned by the outermost circumferential main groove 23 is referred to as the shoulder land portion.

Also, when seen as a cross-section in a tire meridian direction, the point P is taken at an edge portion on the inner side in the tire width direction, and the point T is taken at an edge portion on the outer side in the tire width direction of the shoulder land portion 34. Also, a normal line m is drawn from the point P to the carcass layer 13. The point P, the point T, and the normal line m are defined with the tire assembled on a standard rim to which the regular inner pressure is applied, and the regular air pressure is applied.

Herein, “standard rim” refers to a “standard rim” defined by the Japan Automobile Tyre Manufacturers Association (JATMA), a “design rim” defined by the Tire and Rim Association (TRA), or a “measuring rim” defined by the European Tyre and Rim Technical Organisation (ETRTO). “Regular inner pressure” refers to “maximum air pressure” stipulated by JATMA, a maximum value in “tire load limits at various cold inflation pressures” defined by TRA, and “inflation pressures” stipulated by ETRTO. Note that “regular load” refers to “maximum load capacity” stipulated by JATMA, a maximum value in “tire load limits at various cold inflation pressures” defined by TRA, and “load capacity” stipulated by ETRTO. However, with JATMA, in the case of passenger car tires, the regular internal pressure is an air pressure of 180 kPa, and the regular load is 88% of the maximum load capacity.

At this time, an end portion on the outer side of the circumferential reinforcing layer 145 in the tire width direction is on the outer side in the tire width direction of the normal line m. Also, a distance W1 from the normal line m to the end portion on the outer side in the tire width direction of the circumferential reinforcing layer 145, and a distance L from the point P to the point T on the edge portion on the outer side in the tire width direction of the shoulder land portion 34 have a relationship such that 0.1≦W1/L≦0.4.

Also, the distances W1 and L, and each of the distances W2, W3, Ls, and H which are described later are defined with the tire assembled on a standard rim, filled with the regular inner pressure, and under no load conditions. Also, the following measurement method is used, for example. First, the tire unit is applied and fixed with tape or the like to the imaginary line of the tire profile measured by a laser profiler. Then, the gauge that is to be measured is measured with a calipers or the like. The laser profiler used here is a tire profile measuring device (manufactured by Matsuo Co., Ltd.).

In the configuration in FIG. 2, the point T at the edge portion on the outer side in the tire width direction of the shoulder land portion 34 coincides with the tread edge and with the tire ground contact edge. Therefore, the distance L is the same as the width of the shoulder land portion 34, and is the same as the ground contact width of the shoulder land portion 34. Also, in a configuration in which the outermost circumferential main groove 23 has a zigzag shape (not illustrated), the distance L is calculated as the average value on the whole periphery of the tire.

In the pneumatic tire 1, the circumferential reinforcing layer 145 extends below the groove of the outermost circumferential main groove 23 to below the shoulder land portion 34, so it is possible to reduce the difference in stiffness between the land portions 31 to 33 in the tread center region that is demarcated by the outermost circumferential main groove 23, and the shoulder land portion 34. As a result, uneven wear of the shoulder land portion 34 is suppressed and the uneven wear resistance performance of the tire is thus improved.

Note that, in the pneumatic tire 1, the belt cords that constitute the circumferential reinforcing layer 145 are steel wire, and the circumferential reinforcing layer 145 preferably has not less than 17 ends/50 mm and not more than 30 ends/50 mm. Preferably, the external diameter of the belt cords is in the range of not less than 1.2 mm and not more than 2.2 mm. When the circumferential reinforcing layer is constituted from a plurality of cords formed from the belt cords twisted together, the external diameter of the belt cord is measured as the diameter of a circle that circumscribes the belt cord.

Also, in the pneumatic tire 1, the circumferential reinforcing layer 145 is constituted from a single steel wire that is wound spirally. However, the configuration is not limited thereto, and the circumferential reinforcing layer 145 may be constituted from a plurality of wires wound spirally around side-by-side to each other (multiple winding structure). In this case, preferably, the number of wires is not greater than 5. Also, preferably, the width of winding per unit when 5 wires are wound in multiple layers is not greater than 12 mm. In this way, a plurality (not less than 2 and not greater than 5) of wires can be wound properly at a slant within a range of ±5° with respect to the tire circumferential direction.

Also, in the pneumatic tire 1, preferably (a) the elongation of the belt cords that constitute the circumferential reinforcing layer 145 when they are members (when they are material prior to forming the green tire) when subjected to a tension load of 100 N to 300 N is preferably not less than 1.0% and not greater than 2.5%. Also, preferably (b) the elongation of the belt cords of the circumferential reinforcing layer 145 when they are in the tire (when they are taken from the tire product) when subjected to a tension load of 500 N to 1000 N is preferably not less than 0.5% and not greater than 2.0%. The belt cords (high elongation steel wire) have good elongation when a low load is applied compared with normal steel wire, so they have the property that they can withstand loads. Therefore, in the case of (a) above, it is possible to improve the durability of the circumferential reinforcing layer 145 during manufacture, and in the case of (b) above, it is possible to improve the durability of the circumferential reinforcing layer 145 when the tire is used, which are desirable. The elongation of the belt cord is measured in accordance with JIS G3510.

Also, preferably the width Ws of the circumferential reinforcing layer 145 is preferably in ranges such that 0.60≦Ws/W. When the circumferential reinforcing layer 145 has a divided structure (not illustrated), the width Ws of the circumferential reinforcing layer 145 is the sum of the widths of each divided portion.

Additionally, in the configuration in FIG. 3, the circumferential reinforcing layer 145 is disposed inward in the tire width direction of the left and right edges of the narrower cross belt 143 of the pair of cross belts 142, 143. Also, preferably, a width W of the narrower cross belt 143 and a distance S from the edge of the circumferential reinforcing layer 145 to the edge of the narrower cross belt 143 are in ranges such that 0.03≦S/W. This point is the same even if the circumferential reinforcing layer 145 has a divided structure (not illustrated). The width W and the distance S are measured as distances in the tire width direction when seen as a cross-section in a tire meridian direction. Also, there is no upper limit to the value of S/W in particular, but it is restricted by the relationship of the width Ws of the circumferential reinforcing layer 145 and the width W of the narrower cross belt 143.

Also, preferably, the width Ws of the circumferential reinforcing layer 145 relative to the tire development width TDW (not illustrated) is within ranges such that 0.65≦Ws/TDW≦0.80. The tire development width TDW is the linear distance in a development view between the two edges of the tread-patterned portion of the tire assembled on a standard rim to which a regular inner pressure is applied under no load conditions.

In the configuration in FIG. 2, the circumferential reinforcing layer 145 is disposed so as to be interposed between the pair of cross belts 142, 143 (see FIG. 2). However, the configuration is not limited thereto, and the circumferential reinforcing layer 145 may be disposed on an inner side of the pair of cross belts 142, 143. For example, the circumferential reinforcing layer 145 may be (1) disposed between the high angle belt 141 and the inner-side cross belt 142, or (2) disposed between the carcass layer 13 and the high angle belt 141 (not illustrated).

Also, in the pneumatic tire 1, each of the end portions of the pair of cross belts 142, 143 on the outer side in the tire width direction is on the outer side in the tire width direction than the circumferential reinforcing layer 145. In other words, the cross belts 142, 143 have a wider structure than the circumferential reinforcing layer 145 (see FIGS. 2 and 3). At this time, a distance W2 from the normal line m to the end portion on the outer side in the tire width direction of the wider cross belt 142 of the pair of cross belts 142, 143 and a distance L from the point P to the point T on the edge portion on the outer side in the tire width direction of the shoulder land portion 34 preferably have a relationship such that 0.7≦W2/L≦1.1. Also, a distance W3 from the normal line m to the end portion on the outer side in the tire width direction of the narrower cross belt 143 of the pair of cross belts 142, 143 and the distance W2 preferably have a relationship such that 0.5≦W3/W2≦0.9.

In the configuration in FIG. 2, the inner-side cross belt 142 of the pair of cross belts 142, 143 has the wider structure, and the outer-side cross belt 143 has the narrower structure. However, this is not a limitation, and the inner-side cross belt 142 may have the narrower structure, and the outer-side cross belt 143 may have the wider structure (not illustrated). In this configuration, the end portions of the wider outer-side cross belt 142 are the measurement points for the distance W2, and the end portions of the narrower inner-side cross belt 143 are the measurement points of the distance W3.

Also, in the pneumatic tire 1, preferably, the distance L from the point P to the point T on the edge portion on the outer side in the tire width direction of the shoulder land portion 34, and the tread half width TW (not illustrated) has a relationship such that 0.15≦L/TW≦0.40 (see FIG. 2). The tread half width TW is half the linear distance between the two edges of the tread-patterned portion of the tire assembled on a standard rim to which the regular inner pressure is applied under no load conditions.

### Modified Examples

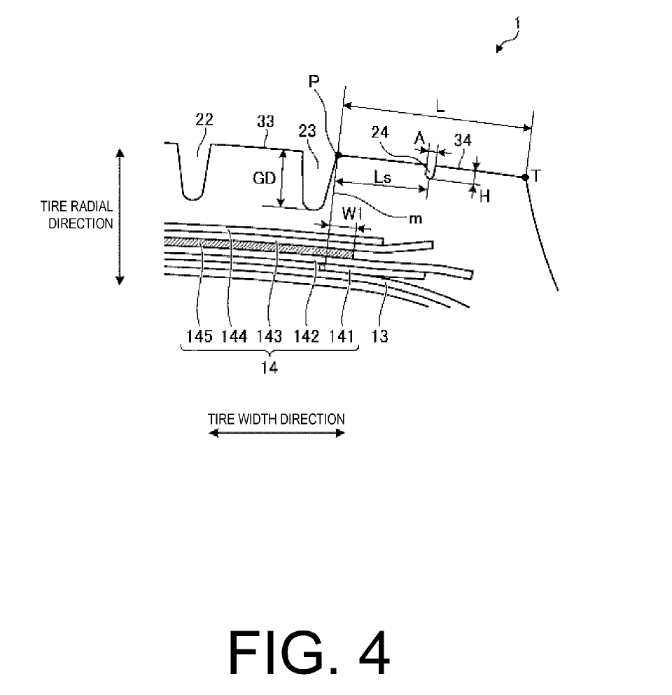

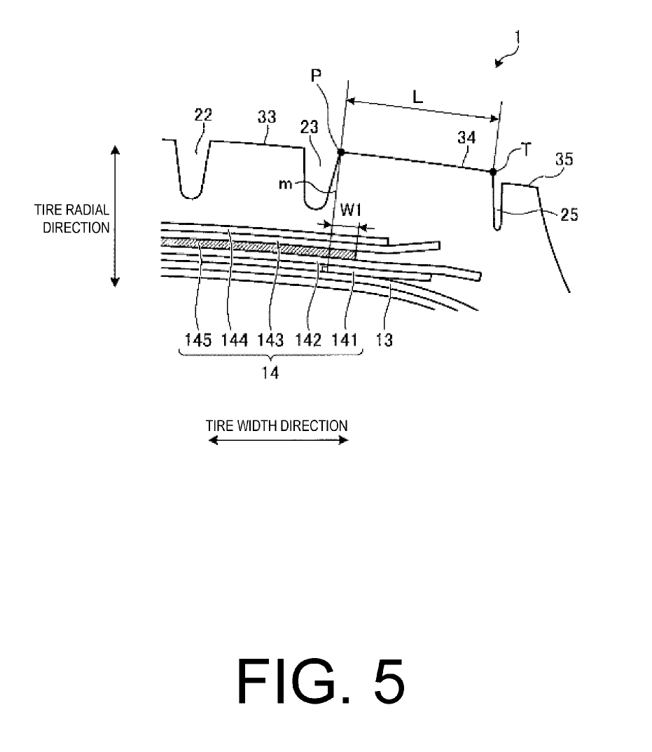

FIGS. 4 and 5 are explanatory views illustrating modified examples of the pneumatic tire 1 depicted in FIG. 1. In these drawings, constituents that are the same as those in FIG. 2 are assigned the same reference numerals and descriptions thereof are omitted.

In the configuration in FIG. 4, the shoulder land portion 34 has a narrow shallow groove 24 extending in the tire circumferential direction to reduce the tire ground contact pressure. The narrow shallow groove 24 is a so-called “hot water groove” provided to suppress uneven wear by reducing the ground contact pressure of the shoulder land portion 34.

In this configuration, preferably, the narrow shallow groove 24 is disposed on the outer side in the tire width direction from the circumferential reinforcing layer 145. In other words, the distance W1 from the normal line m to the end portion on the outer side in the tire width direction of the circumferential reinforcing layer 145 and the distance Ls from the point P to the narrow shallow groove 24 have a relationship such that W1<Ls. Also, at this time, preferably, the distance Ls from the point P to the narrow shallow groove 24 and the distance L have a relationship such that 0.05≦Ls/L≦0.7. As a result, the positional relationship between the narrow shallow groove 24 and the circumferential reinforcing layer 145 is made appropriate.

Also, preferably, a width A of the narrow shallow groove 24 and the distance L have a relationship such that 0.05≦A/L≦0.15. Also, preferably, a groove depth H of the narrow shallow groove 24 and a groove depth GD of the outermost circumferential main groove 23 have a relationship such that 0.05≦H/GD≦0.25. As a result, the width A of the narrow shallow groove 24 and the groove depth H are made appropriate.

Also, in the configuration in FIG. 5, the pneumatic tire 1 has a narrow groove 25 that extends in the tire circumferential direction and a narrow rib 35 that is formed by being partitioned by the narrow groove 25 at an edge portion on the outer side in the tire width direction of the shoulder land portion 34. Also, the road contact surface of the narrow rib 35 is disposed offset inward in the tire radial direction from the road contact surface of the shoulder land portion 34. In this configuration, when the tire is rotating, the narrow rib 35 functions as a so-called sacrificial rib, that suppresses uneven wear of the shoulder land portion 34.

Here, in the configuration having the narrow rib 35 as described above, regardless of whether or not the narrow rib 35 contacts the ground under the prescribed measurement conditions, the point T is taken at the edge portion (the edge portion partitioned by the narrow groove 25) on the outer side in the tire width direction of the shoulder land portion 34, and the distance L is measured accordingly. In other words, the arrangement of the circumferential reinforcing layer 145 is made appropriate using the edge portion of the shoulder land portion 34, for which uneven wear is to be suppressed, as the criterion. As a result, the uneven wear resistance performance of the tire is enhanced.

### Effect

As described above, the pneumatic tire 1 includes the carcass layer 13 and the belt layer 14 that is formed by laminating the pair of cross belts 142, 143 and the circumferential reinforcing layer 145 and that is disposed outward in the tire radial direction of the carcass layer 13 (see FIG. 2). Additionally, the pneumatic tire 1 includes the plurality of circumferential main grooves 21 to 23 extending in a tire circumferential direction, and the plurality of land portions 31 to 34 partitioned by the circumferential main grooves 21 to 23 in the tread portion. Also, the end portion on the outer side in the tire width direction of the circumferential reinforcing layer 145 is on the outer side in the tire width direction of the normal line m that is drawn from the point P at the edge portion on the inner side in the tire width direction of the shoulder land portion 34 to the carcass layer 13. The distance W1 from the normal line m to the end portion of the circumferential reinforcing layer 145 on the outer side in the tire width direction, and the distance L from the point P to the point T at the edge portion on the outer side in the tire width direction of the shoulder land portion 34 have a relationship such that 0.1≦W1/L≦0.4.

In this configuration, the circumferential reinforcing layer 145 extends below the groove of the outermost circumferential main groove 23 to below the shoulder land portion 34, so it is possible to reduce the difference in stiffness between the land portions 31 to 33 in the tread center region that is demarcated by the outermost circumferential main groove 23, and the shoulder land portion 34. This leads to the advantage that the uneven wear of the shoulder land portion 34 is suppressed and that the uneven wear resistance performance of the tire is thus improved.

Also, in the pneumatic tire 1, each of the end portions of the pair of cross belts 142, 143 on the outer side in the tire width direction is on the outer side in the tire width direction than the circumferential reinforcing layer 145 (see FIG. 2). Also, the distance W2 from the normal line m to the end portion on the outer side in the tire width direction of the wider cross belt 142 of the pair of cross belts 142, 143 and the distance L from the normal line m to the point T at the edge portion on the outer side in the tire width direction of the shoulder land portion 34 have a relationship such that 0.7≦W2/L≦1.1. In this configuration, the positions of the end portions on the outer side in the tire width direction of the wider cross belt 142 is made appropriate, and this leads to the advantage that the tire durability performance is properly ensured.

Also, in the pneumatic tire 1, the distance W3 from the normal line m to the end portion on the outer side in the tire width direction of the narrower cross belt 143 of the pair of cross belts 142, 143 and the distance W2 have a relationship such that 0.5≦W3/W2≦0.9 (see FIG. 2). In this configuration, the position of the end portion on the outer side in the tire width direction of the narrower cross belt 143 is made appropriate, and this leads to the advantage that the durability performance of the tire is properly ensured.

Also, in the pneumatic tire 1, the distance L from the point P to the point T at the edge portion on the outer side in the tire width direction of the shoulder land portion 34, and the tread half width TW has a relationship such that 0.15≦L/TW≦0.40 (see FIG. 2). In this configuration, the width of the shoulder land portion 34 is made appropriate by making the distance L appropriate. As a result, the stiffness of the shoulder land portion is made appropriate, and this leads to the advantage that the tire uneven wear resistance performance is improved.

Also, in the pneumatic tire 1, the shoulder land portion 34 has a narrow shallow groove 24 to reduce the tire ground contact pressure, extending in the circumferential direction of the tire, and the narrow shallow groove 24 is on the outer side in the tire width direction of the circumferential reinforcing layer 145 (see FIG. 4). In this configuration, the positional relationship between the narrow shallow groove 24 and the circumferential reinforcing layer 145 is made appropriate, so the action of reducing the ground contact pressure of the shoulder land portion 34 by the narrow shallow groove 24 is increased. This construction leads to an enhancement in the uneven wear resistance performance of the tire.

Also, in the pneumatic tire 1, the distance Ls from the point P to the narrow shallow groove 24 and the distance L have a relationship such that 0.05≦Ls/L≦0.7 (see FIG. 4). As a result, the position of the narrow shallow groove 24 on the shoulder land portion 34 is made appropriate, and this leads to the advantage that the action of reducing the ground contact pressure of the shoulder land portion 34 by the narrow shallow groove 24 is increased.

Also, in the pneumatic tire 1, the width A of the narrow shallow groove 24 and the distance L from the point P to the point T at the edge portion on the outer side in the tire width direction of the shoulder land portion 34 have a relationship such that 0.05≦A/L≦0.15, and, the groove depth H of the narrow shallow groove 24 and the groove depth GD of the outermost circumferential main groove 23 have a relationship such that 0.05≦H/GD≦0.25 (see FIG. 4). As a result, the width A and the groove depth H of the narrow shallow groove 24 are made appropriate, and this leads to the advantage that the action of reducing the ground contact pressure of the shoulder land portion 34 by the narrow shallow groove 24 is increased.

Also, in the pneumatic tire 1, the belt cords that constitute the circumferential reinforcing layer 145 are steel wire, and the circumferential reinforcing layer 145 has not less than 17 ends/50 mm and not more than 30 ends/50 mm.

Also, in the pneumatic tire 1, the elongation of the belt cords that constitute the circumferential reinforcing layer 145 when they are members when subjected to a tension load of 100 N to 300 N is not less than 1.0% and not greater than 2.5%.

Also, in the pneumatic tire 1, the elongation of the belt cords that constitute the circumferential reinforcing layer 145 when they are in the tire when subjected to a tension load of 500 N to 1000 N is not less than 0.5% and not greater than 2.0%.

Also, in the pneumatic tire 1, the circumferential reinforcing layer 145 is disposed inward in the tire width direction from the left and right edges of the narrower cross belt 143 of the pair of cross belts 142, 143 (see FIG. 3). Also, the width W of the narrower cross belt 143 and the distance S from the edge of the circumferential reinforcing layer 145 to the edge of the narrower cross belt 143 are in the ranges such that 0.03≦S/W. As a result, the positional relationship S/W of the edges of the cross belts 142, 143 and the edge of the circumferential reinforcing layer 145 is made appropriate, and this has the advantage that it is possible to reduce strain that is produced in the rubber material around the circumferential reinforcing layer 145.

Also, in the pneumatic tire 1, the width W of the narrower cross belt 143 and the width Ws of the circumferential reinforcing layer 145 have a relationship such that 0.60≦Ws/W (see FIG. 3).

Also, in the pneumatic tire 1, the width Ws of the circumferential reinforcing layer 145 relative to the tire development width TDW (not illustrated) is within the ranges such that 0.65≦Ws/TDW≦0.80. In this configuration, because Ws/TDW≦0.80, the width Ws of the circumferential reinforcing layer 145 is made appropriate, and this leads to the advantage that fatigue failure of the belt cords in the edges of the circumferential reinforcing layer 145 is suppressed. Also, because 0.65≦Ws/TDW, the tire ground contact shape is made appropriate, and this leads to the advantage that the tire uneven wear resistance performance is improved.

### Target of Application

It is preferable that the pneumatic tire 1 be applied to a heavy-duty tire. In a heavy-duty tire, the load is large when the tire is used, compared with a tire for a passenger car. Therefore, the difference in diameter between the disposal region of the circumferential reinforcing layer and the region on the outer side in the tire width direction of the circumferential reinforcing layer becomes large, and uneven wear can easily occur in the shoulder land portion. Hence, by targeting these heavy-duty pneumatic tires for application, there is an advantage that a greater effect of suppressing uneven wear can be obtained.

Also, preferably, the pneumatic tire 1 is applied to tires with an aspect ratio of not less than 40% and not more than 70%, in the state where the tire is assembled on a standard rim, the regular inner pressure is applied to the tire, and the regular load is applied. In addition, the pneumatic tire 1, as in this embodiment, is preferably used as a pneumatic tire for heavy loads, such as buses, trucks and the like. With tires having this aspect ratio (in particular, pneumatic tires for heavy loads such as buses, trucks and the like) the ground contact shape can easily become hourglass-shape, and uneven wear can easily occur in the shoulder land portion. Therefore, by targeting tires with these aspect ratios for application, a greater effect of suppressing uneven wear can be obtained.

Also, preferably, the pneumatic tire 1 is applied to tires having the tread edge and the tire ground contact edge at the edge portion (the point T) on the outer side in the tire width direction of the shoulder land portion 34, as in FIG. 2. In this configuration, uneven wear can easily occur in the edge of the shoulder land portion 34. Therefore, by targeting tires with this configuration for application, a greater effect of suppressing uneven wear can be obtained.

### Working Examples

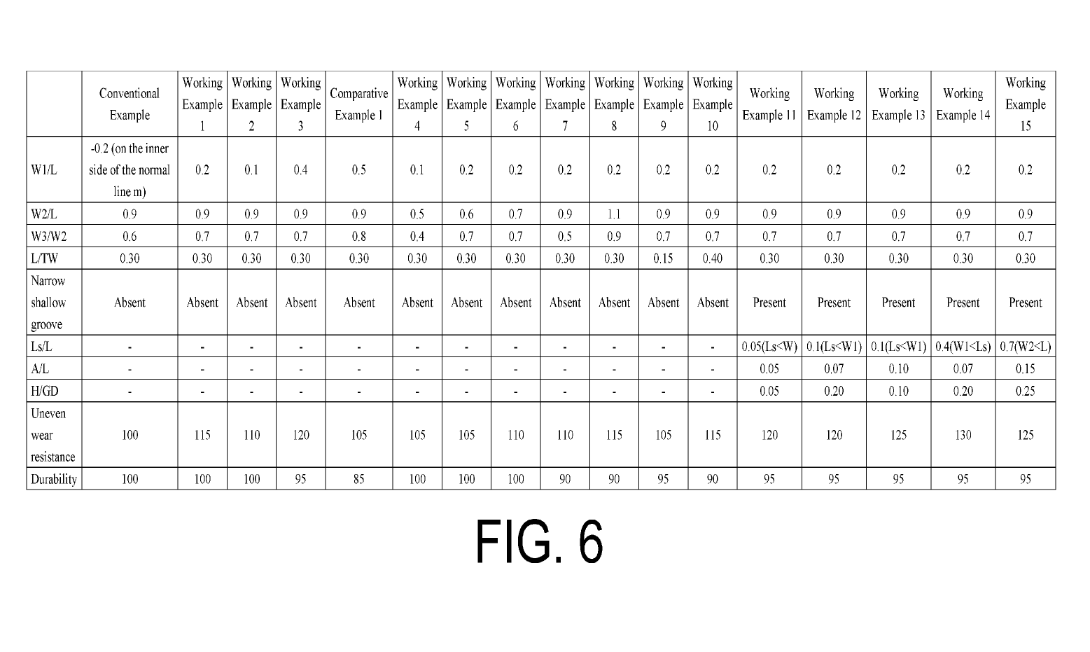

FIG. 6 is a table showing the results of performance testing of pneumatic tires according to the embodiment of the present invention.

In the performance testing, a plurality of mutually differing pneumatic tires were evaluated for (1) uneven wear resistance performance, and (2) durability performance (see FIG. 6). Also, pneumatic tires with a tire size of 445/50R22.5 were assembled on a rim having a rim size 22.5×14.00, and an air pressure of 900 kPa and a load of 4625 kg/tire were applied to these pneumatic tires. Also, the pneumatic tires were mounted on a 6×4 tractor-trailer test vehicle.

(1) In the evaluation of the uneven wear resistance performance, the test vehicle was run on normal roads for 100,000 km, and then the amount of shoulder rounding wear of the shoulder land portion (the difference between the amount of wear at the edge portion on the outer side in the tire width direction of the shoulder land portion and the amount of wear of the outermost circumferential main groove) was measured. Evaluations were performed by indexing the measurement results with the Conventional Example as the standard score (100). In this evaluation, higher scores were preferable.

(2) Durability evaluation was carried out with low pressure durability tests using an indoor drum testing machine. Then, while traveling at 45 km/h, the load was increased by 5% every 24 hours from the load described above, and when the tire broke down, the distance traveled was measured. Evaluations were performed by indexing the measurement results with the Conventional Example as the standard score (100). In this evaluation, higher scores were preferable. Also, if the evaluation was in the range from 90 to 100, it was concluded that the durability was properly secured.

The pneumatic tires 1 of the Working Examples 1 to 10 had the configuration in FIGS. 1 to 3, and the pneumatic tires 1 of the Working Examples 11 to 15 had the configuration in FIG. 4. Also, the width L of the shoulder land portion (the distance L from the point P to the point T) was L=50 mm, and the tread half width TW was TW=200 mm. Also, the groove depth GD of the outermost circumferential main groove 23 was GD=20 mm. Also, the belt cords that constitute the circumferential reinforcing layer 145 were steel wire, and the circumferential reinforcing layer 145 had 20 ends/50 mm. Also, the elongation of the belt cords of the circumferential reinforcing layer 145 when subjected to a tension load of 100 N to 300 N was 1.8%.

In the configuration in FIG. 2, the pneumatic tires of the Conventional Example had the end portion on the outer side in the tire width direction of the circumferential reinforcing layer positioned on the inner side in the tire width direction of the normal line m (not illustrated).

As can be seen from the test results, in the pneumatic tires 1 according to Working Examples 1 to 15, the tire uneven wear resistance performance was improved, while maintaining the durability performance.

What is claimed is:

1. A pneumatic tire, comprising: a carcass layer; a belt layer that is formed by laminating a pair of cross belts and a circumferential reinforcing layer and that is disposed on an outer side in a tire radial direction of the carcass layer; and a plurality of circumferential main grooves that extend in a tire circumferential direction and a plurality of land portions partitioned by the circumferential main grooves in a tread portion, wherein,
when the circumferential main groove on an outermost side in a tire width direction is referred to as an outermost circumferential main groove, and the land portion on the outer side in the tire width direction that is partitioned by the outermost circumferential main groove is referred to as a shoulder land portion,
an end portion on the outer side in the tire width direction of the circumferential reinforcing layer is on the outer side in the tire width direction of a normal line m drawn from a point P at an edge portion on an inner side in the tire width direction of the shoulder land portion to the carcass layer, and
a distance W1 from the normal line m to the end portion on the outer side in the tire width direction of the circumferential reinforcing layer, and a distance L from the point P to a point T at an edge portion on the outer side in the tire width direction of the shoulder land portion have a relationship such that 0.1≦W1/L≦0.4,
the shoulder land portion includes a narrow shallow groove that extends in the tire circumferential direction and that reduces a tire ground contact pressure,
the narrow shallow groove is disposed on the outer side in the tire width direction of the circumferential reinforcing layer, and
a distance Ls, from the point P to the narrow shallow groove, and the distance L have a relationship such that 0.05≦Ls/L≦0.7.

2. The pneumatic tire according to claim 1, wherein each of the end portions on the outer side in the tire width direction of the pair of cross belts is disposed on the outer side in the tire width direction of the circumferential reinforcing layer, and
a distance W2 from the normal line m to the end portion on the outer side in the tire width direction of a wider cross belt of the pair of cross belts, and the distance L have a relationship such that 0.7≦W2/L≦1.1.

3. The pneumatic tire according to claim 2, wherein a distance W3 from the normal line m to the end portion on the outer side in the tire width direction of a narrower cross belt of the pair of cross belts, and the distance W2 have a relationship such that 0.5≦W3/W2≦0.9.

4. The pneumatic tire according to claim 1, wherein the distance L and a tread half width TW have a relationship such that 0.15≦L/TW≦0.40.

5. (canceled)

6. (canceled)

7. The pneumatic tire according to claim 5, wherein a width A of the narrow shallow groove and the distance L have a relationship such that 0.05≦A/L≦0.15, and, a groove depth H of the narrow shallow groove and a groove depth GD of the outermost circumferential main groove have a relationship such that 0.05≦H/GD≦0.25.

8. The pneumatic tire according to claim 1, wherein belt cords that constitute the circumferential reinforcing layer are steel wire, and a number of ends of the circumferential reinforcing layer is not less than 17 ends/50 mm and not more than 30 ends/50 mm.

9. The pneumatic tire according to claim 1, wherein elongation of belt cords that constitute the circumferential reinforcing layer when they are members, when subjected to a tension load of 100 N to 300 N is not less than 1.0% and not greater than 2.5%.

10. The pneumatic tire according to claim 1, wherein elongation of belt cords that constitute the circumferential reinforcing layer when in the tire, when subjected to a tension load of 500 N to 1000 N is not less than 0.5% and not greater than 2.0%.

11. The pneumatic tire according to claim 1, wherein the circumferential reinforcing layer is disposed inward in the tire width direction of left and right edges of the narrower cross belt of the pair of cross belts, and the width W of the narrower cross belt and a distance S from an edge of the circumferential reinforcing layer to an edge of the narrower cross belt are in ranges such that 0.03≦S/W.

12. The pneumatic tire according to claim 1, wherein the circumferential reinforcing layer is disposed inward in the tire width direction of the left and right edges of the narrower cross belt of the pair of cross belts, and
the width W of the narrower cross belt and a width Ws of the circumferential reinforcing layer are in ranges such that 0.60≦Ws/W.

13. The pneumatic tire according to claim 1, wherein the width Ws of the circumferential reinforcing layer relative to a tire development width TDW is in ranges such that 0.65≦Ws/TDW≦0.80.

14. The pneumatic tire according to claim 1, applied to a tire with aspect ratio of not greater than 70%.

15. The pneumatic tire according to claim 1, wherein each of the end portions on the outer side in the tire width direction of the pair of cross belts is disposed on the outer side in the tire width direction of the circumferential reinforcing layer,
a distance W2 from the normal line m to the end portion on the outer side in the tire width direction of a wider cross belt of the pair of cross belts, and the distance L have a relationship such that 0.7≦W2/L≦1.1,
a distance W3 from the normal line m to the end portion on the outer side in the tire width direction of a narrower cross belt of the pair of cross belts, and the distance W2 have a relationship such that 0.5≦W3/W2≦0.9, and
the distance L and a tread half width TW have a relationship such that 0.15≦L/TW≦0.40.

16. (canceled)

17. The pneumatic tire according to claim 1, wherein elongation of belt cords that constitute the circumferential reinforcing layer when they are members, when subjected to a tension load of 100 N to 300 N is not less than 1.0% and not greater than 2.5%, and when subjected to a tension load of 500 N to 1000 N is not less than 0.5% and not greater than 2.0%.

18. The pneumatic tire according to claim 1, wherein:
the width Ws of the circumferential reinforcing layer relative to a tire development width TDW is in ranges such that 0.65≦Ws/TDW≦0.80, and
the circumferential reinforcing layer is disposed inward in the tire width direction of left and right edges of the narrower cross belt of the pair of cross belts, and the width W of the narrower cross belt and a distance S from an edge of the circumferential reinforcing layer to an edge of the narrower cross belt are in ranges such that 0.03≦S/W.

19. The pneumatic tire according to claim 1, wherein:
the width Ws of the circumferential reinforcing layer relative to a tire development width TDW is in ranges such that 0.65≦Ws/TDW≦0.80,
the circumferential reinforcing layer is disposed inward in the tire width direction of the left and right edges of the narrower cross belt of the pair of cross belts, and
the width W of the narrower cross belt and a width Ws of the circumferential reinforcing layer are in ranges such that 0.60≦Ws/W.

20. The pneumatic tire according to claim 1, wherein:
each of the end portions on the outer side in the tire width direction of the pair of cross belts is disposed on the outer side in the tire width direction of the circumferential reinforcing layer,
a distance W2 from the normal line m to the end portion on the outer side in the tire width direction of a wider cross belt of the pair of cross belts, and the distance L have a relationship such that 0.7≦W2/L≦1.1, and
belt cords that constitute the circumferential reinforcing layer are steel wire, and a number of ends of the circumferential reinforcing layer is not less than 17 ends/50 mm and not more than 30 ends/50 mm.
